(19) United States
(12) Patent Application Publication
(10) Pub. No.: US 2004/0257421 A1
(43) Pub. Date: Dec. 23, 2004

(54) Liquid ejecting apparatus

(75) Inventors: Koichiro Yokoyama, Nagano-ken (JP); Satoshi Noda, Nagano-ken (JP); Hikaru Kobayashi, Nagano-ken (JP); Hitoshi Yazaki, Nagano-ken (JP); Hiroshi Hamakawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/821,245

(22) Filed: Apr. 9, 2004

(30) Foreign Application Priority Data
Apr. 10, 2003 (JP) 2003-106986
Apr. 10, 2003 (JP) 2003-106987
Mar. 19, 2004 (JP) 2004-081470

(51) Int. Cl. B41J 2/01

(52) U.S. Cl. 347/104

(57) ABSTRACT

A liquid ejecting apparatus includes a plurality of first transfer rollers separately provided from each other in a substantially same line along a main scanning direction crossing a feeding direction of the recording material, for transferring the recording material in the feeding direction while bending the recording material inwards on a liquid ejection surface of the recording material in the liquid ejection area, a plurality of first ribs disposed in the liquid ejection area for supporting the recording material on a surface of the recording material opposite the liquid ejection surface, the first ribs being placed at substantially same positions in the main scanning direction as the first transfer rollers respectively, directions and distances of the first ribs from the first transfer rollers in the feeding direction being substantially equal to each other, and a first liquid absorption material disposed between the first transfer rollers and the first ribs for absorbing the liquid.

This patent application claims priority from Japanese patent applications Nos. 2003-106986 and 2003-106987 both filed on Apr. 10, 2003, and 2004-081470 filed on Mar. 19, 2004, the contents of which are incorporated herein by reference.

### BACKGROUND OF THE INVENTION

1. Field of the Invention

The present invention relates to a liquid ejecting apparatus. More particularly, the present invention relates to a liquid ejecting apparatus for ejecting liquid onto a recording material being conveyed to a liquid ejection area.

2. Description of the Related Art

A liquid ejecting apparatus such as an inkjet type recording apparatus includes feed rollers for conveying the recording material to the liquid ejection area, and a liquid ejecting head for performing recording by ejecting liquid onto the recording material at the liquid ejection area. A plurality of the feed rollers of the inkjet type recording apparatus are arranged in approximately the same direction as the feeding direction. The feed rollers being distanced from each other convey the recording material obliquely downwards, i.e. in the direction away from the liquid ejecting head in the liquid ejection area. Recording is performed on the recording material conveyed into the liquid ejection area by ejecting liquid onto it from the liquid ejecting head. Here, there is an inkjet type recording apparatus for performing recording over the entire liquid ejection surface of the recording material, called recording with no margin as disclosed in Japanese Patent Application Laid-Open Nos. 2002-103586 and 2002-264319.

The liquid ejecting apparatus generally has a positioning tolerance with respect to recording materials. Accordingly, if recording is performed on the upper and lower ends of the recording material, the edge of the liquid ejection surface of the recording material might be placed out of the position right below the ejection holes of the liquid ejecting head. Therefore, it happens that the liquid does not stick onto a certain area of the recording material. In addition, since there is an error in the liquid ejection accuracy of the liquid ejecting head as well, even if the recording material is placed right below the liquid ejecting head, the liquid might not stick onto the area of the recording material right below the liquid ejecting head. In order to prevent this, it is necessary for the inkjet type recording apparatus to eject liquid even onto the area around the periphery of the recording material in which the recording material is not placed.

Accordingly, since the liquid is ejected onto the area where the recording material is not placed, it might stick to a member supporting the recording material. In this case, when recording is consecutively performed, the second recording material or later is stained with the liquid by touching the member stuck with it. In addition, the recording material is conveyed to the liquid ejection area by a plurality of separated feed rollers while being partially pushed downwards. Accordingly, the recording material conveyed to the liquid ejection area might be bent downwards at its parts positioned in the same lines in the feeding direction as the feed rollers. If the liquid is ejected onto the recording material in such state, the image to be recorded might be warped.

### SUMMARY OF THE INVENTION

Therefore, it is an object of the present invention to provide a liquid ejecting apparatus, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, a liquid ejecting apparatus for performing recording on a recording material fed to a liquid ejection area by ejecting liquid onto the recording material, includes a plurality of first transfer rollers separately provided from each other in a substantially same line along a main scanning direction crossing the feeding direction of the recording material, for transferring the recording material in the feeding direction while bending the recording material inwards on a liquid ejection surface of the recording material in the liquid ejection area, a plurality of first ribs disposed in the liquid ejection area for supporting the recording material on a surface of the recording material opposite the liquid ejection surface, the first ribs being placed at substantially same positions in the main scanning direction as the first transfer rollers respectively, directions and distances of the first ribs from the first transfer rollers in the feeding direction being substantially equal to each other, and a first liquid absorption material disposed between the first transfer rollers and the first ribs for absorbing the liquid. Accordingly, when the liquid is ejected onto the end parts of the recording material between the first transfer rollers and the first ribs, the part of the recording material on which recording will be next performed is hardly stained with the liquid not previously sticking to the recording material. In addition, the liquid ejecting apparatus suppresses the wave-shaped bends of the recording material caused by the first transfer rollers, so that it can perform recording onto the recording material accurately.

The first transfer rollers may feed the recording material to the liquid ejection area, and the first ribs may be disposed downstream of the feeding direction of the recording material against the first transfer rollers. Accordingly, the liquid ejecting apparatus can perform recording onto an upper end of the recording material.

The liquid ejecting apparatus may further include a plurality of second transfer rollers disposed downstream of the feeding direction of the recording material against the first liquid absorption material, for feeding the recording material out of the liquid ejection are a while bending the recording material inwards on a liquid ejection surface of the recording material in the liquid ejection area, a plurality of second ribs disposed in the liquid ejection area for supporting the recording material on the surface of the recording material opposite the liquid ejection surface, the second ribs being placed at substantially same positions in the main scanning direction as the second transfer rollers respectively, and being placed at a substantially same position between the second transfer rollers and the first ribs in the feeding direction, and a second liquid absorption material disposed between the second transfer rollers and the second ribs for absorbing the liquid. Accordingly, the liquid ejecting apparatus can perform recording onto both the upper and lower ends of the recording material.

The second transfer rollers and second ribs may be arranged at substantially same positions in main scanning direction as the first transfer rollers and first ribs respectively. Accordingly, the liquid ejecting apparatus can surely suppress the wave-shaped bends of the recording material caused by the first and second transfer rollers in the liquid ejection area.

The first transfer rollers may feed the recording material out of the liquid ejection area, and the first ribs may be disposed upstream of the feeding direction of the recording material against the first transfer rollers. Accordingly, the liquid ejecting apparatus can perform recording onto the upper end of the recording material.

According to the second aspect of the present invention, a liquid ejecting apparatus for performing recording on a recording material by ejecting liquid onto the recording material, includes a liquid ejecting head reciprocating in a main scanning direction substantially crossing a feeding direction of the recording material, a plurality of main nozzle arrays separately provided from each other in the feeding direction on a surface of the liquid ejecting head facing the recording material for ejecting different main liquid respectively, an upstream sub-nozzle array provided on the surface of the liquid ejecting head facing the recording material for ejecting sub-liquid onto an area different from that of the main liquid, the upstream sub-nozzle array being disposed at a substantially same position in the feeding direction as one of the main nozzle arrays positioned most upstream of the feeding direction, at least one support rib disposed to face areas between the main nozzle arrays via the recording material for supporting the recording material, and a control unit for controlling the sub-liquid to be ejected from the upstream sub-nozzle array, when the main and sub-liquid is ejected onto an upper end of the recording material. Accordingly, the liquid ejecting apparatus can eject the main liquid of a plurality of colors and the sub-liquid onto the recording material in an overlapping manner. In addition, if necessary, the liquid ejecting apparatus can eject the sub-liquid prior to the main liquid onto the recording material.

The liquid ejecting head may further include a downstream sub-nozzle array provided at a substantially same position in the feeding direction as one of the main nozzle arrays positioned most downstream of the feeding direction for ejecting the sub-liquid onto an area different from that of the main liquid, and the control unit may use the upstream sub-nozzle array when the sub-liquid is ejected onto the upper end of the recording material, where as using the downstream sub-nozzle array when the sub-liquid is ejected onto a lower end of the recording material, in case only the sub-liquid is ejected onto the recording material without ejection of the main liquid. Accordingly, it is possible to improve the throughput of liquid ejection with regard to the recording material.

The liquid ejecting apparatus may further include an auxiliary sub-nozzle array disposed between the upstream and downstream sub-nozzle arrays in the feeding direction, wherein the control unit may use the upstream, downstream, and auxiliary sub-nozzle arrays when the sub-liquid is ejected onto an area except the upper and lower ends of the recording material. Accordingly, it is possible to increase the ejection efficiency of the sub-liquid to the recording material.

The liquid ejecting apparatus may be an inkjet type recording apparatus, and the liquid ejecting head may eject ink of a plurality of colors except black for color recording from the plurality of main nozzle arrays, whereas ejecting black ink from the sub-nozzle arrays. On the recording material after recording is performed by the inkjet type recording apparatus, black ink is considerably spread in comparison to other color ink. According to the inkjet type recording apparatus of this aspect, however, black ink is hardly spread because it not ejected after ejection of other color ink. Therefore, recording quality is improved.

According to the third aspect of the present invention, a liquid ejecting apparatus for performing recording on a recording material by ejecting liquid onto the recording material includes a liquid ejecting head reciprocating in a main scanning direction substantially crossing a feeding direction of the recording material, a plurality of nozzle arrays separately provided from each other in the feeding direction on a surface of the liquid ejecting head facing the recording material for ejecting liquid respectively, and at least one support rib disposed to face areas between the main nozzle arrays via the recording material for supporting the recording material, wherein a plurality of recess sections are formed extending in the main scanning direction at positions facing the nozzle arrays via the recording material respectively and dented to be lower than the support rib around the support rib. Accordingly, since the liquid not sticking to the recording material when ejected from the nozzle arrays is received by the recess sections, it is possible to prevent the liquid from sticking to the support rib. Therefore, the recording material conveyed on the support rib is prevented from being stained.

The liquid ejecting apparatus may further include at least one liquid absorption material disposed in the recess sections for absorbing liquid ejected from the nozzle arrays. Accordingly, the liquid not sticking to the recording material is absorbed into the liquid absorption material, so that it is possible to prevent the recording material from being stained with the liquid.

The liquid ejecting apparatus may further include a plurality of first transfer rollers separately provided from each other in an approximately same line along the main scanning direction, for transferring the recording material in the feeding direction while bending the recording material in wards on a liquid ejection surface of the recording material at a position facing the liquid ejecting head, and a plurality of second transfer rollers disposed downstream of the feeding direction against the support rib, for feeding the recording material out of the position facing the liquid ejecting head while bending the recording material inwards on the liquid ejection surface at the position facing the liquid ejecting head, wherein the support rib may include a plurality of first ribs placed at substantially same positions in the main scanning direction as the first transfer rollers respectively, directions and distances of the first ribs from the first transfer rollers in the feeding direction being substantially equal to each other, and a plurality of second ribs placed at substantially same positions in the main scanning direction as the second transfer rollers respectively, and being placed at a substantially same position between the second transfer rollers and the first ribs in the feeding direction. Accordingly, the liquid ejecting apparatus can surely suppress the wave-shaped bends of the recording material caused by the first and second transfer rollers in the liquid ejection area. Therefore, the distances between the recording material and the nozzle arrays can be maintained constantly, and recording quality can be improved.

The liquid ejecting apparatus may further include a control unit for controlling the nozzle arrays, wherein the plurality of nozzle arrays may include an upstream nozzle array and a downstream nozzle array disposed downstream of the feeding direction against the upstream nozzle array, and the control unit may use the upstream nozzle array when the liquid is ejected onto an upper end of the recording material, whereas using the downstream nozzle array when the liquid is ejected onto a lower end of the recording material. Accordingly, the throughput of liquid ejection to the recording material can be improved.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a perspective view of an inkjet type recording apparatus.

FIG. 2 shows a side view of an inkjet type recording apparatus.

FIG. 3 shows a sectional view of a support member.

FIG. 4 shows the position relation between nozzle arrays and a support member.

FIG. 5 shows a recording material whose upper end passing over a first liquid absorption material in a color mode.

FIG. 6 shows a section C-C in FIG. 5.

FIG. 7 shows a recording material whose upper end passing over a third liquid absorption material in a color mode.

FIG. 8 shows a section C-C in FIG. 7.

FIG. 9 shows a recording material whose upper end passing over a second liquid absorption material in a color mode.

FIG. 10 shows a section D-D in FIG. 9.

FIG. 11 shows a recording material whose lower end passing over a first liquid absorption material in a color mode.

FIG. 12 shows a section E-E in FIG. 11.

FIG. 13 shows a recording material whose lower end passing over a third liquid absorption material in a color mode.

FIG. 14 shows a section F-F in FIG. 13.

FIG. 15 shows a recording material whose lower end passing over a second liquid absorption material in a color mode.

FIG. 16 shows a section F-F in FIG. 15.

FIG. 17 shows a recording sequence in which recording is performed on an upper end in a black and white mode.

FIG. 18 shows a recording sequence in which recording is performed on an upper end in a black and white mode.

FIG. 19 shows a modified embodiment of the plane configuration of a support member.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

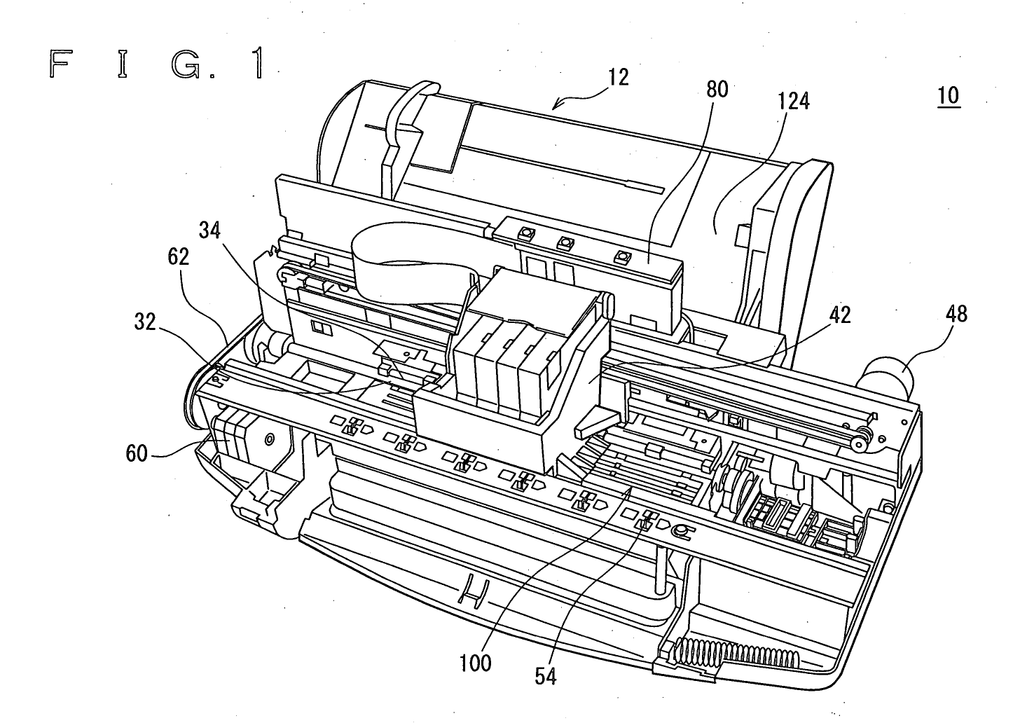

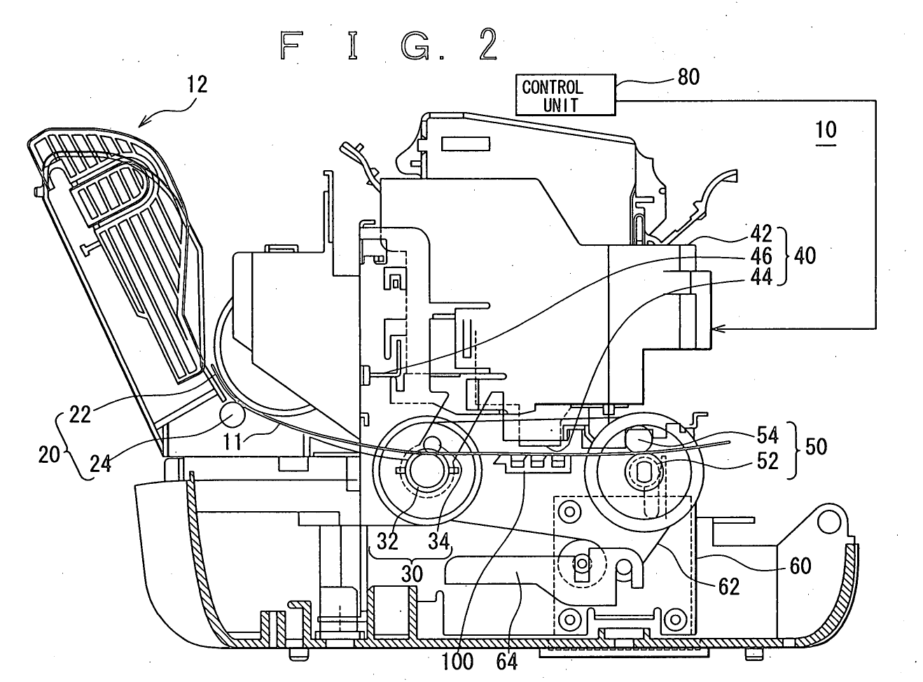

FIG. 1 shows a perspective view of an inkjet type recording apparatus 10, and FIG. 2 shows a side view of the inkjet type recording apparatus 10. Further, the inkjet type recording apparatus 10 is shown together with a recording material 11 on recording in FIG. 2.

The inkjet type recording apparatus 10 performs recording on the recording material 11 disposed in a liquid ejection area by ejecting liquid from nozzle arrays of a recording head 44. Particularly, the inkjet type recording apparatus 10 in this embodiment performs recording from the upper end to the lower end of the recording material 11 without staining the recording material 11. In this case, the inkjet type recording apparatus 10 has two modes which are a color mode using ink with a plurality of colors and a black and white mode using black ink. When the inkjet type recording apparatus 10 performs recording on the recording material 11 in the color mode, it ejects black, cyan, magenta and yellow ink from the nozzle arrays of the recording head 44 onto the recording material 11 disposed in the liquid ejection area. Meanwhile, when it performs recording on the recording material 11 in the black and white mode, it ejects only black ink from the nozzle arrays of the recording head 44. Here, the inkjet type recording apparatus 10 determines the nozzles from which the black ink is ejected by changing the recording mode so as to improve the throughput of recording.

The inkjet type recording apparatus 10 includes a support member 100 for supporting the recording material 11 in the liquid ejection area on the non-liquid ejection surface opposite the liquid ejection surface of the recording material 11, i.e. below the recording material 11. The shape of the support member 100 is designed to perform recording on both the upper and lower ends of the recording material 11 in accordance with the configuration of the nozzle arrays disposed on the recording head 44. And it is also designed in order that the recording material 11 is hardly bent in the form of a wave in the liquid ejection area.

The inkjet type recording apparatus 10 includes, besides the recording head 44 and the support member 100, a tray 12 for holding a plurality of recording materials 11, a hopper 124 for pushing the recording material 11 out of the tray 12, a feed unit 20 for feeding the recording material 11 being pushed out of the tray 12, a conveying unit 30 for conveying the recording material 11 fed by the feed unit 20 to the liquid ejection area, a recording unit 40 for perform recording on the recording material 11 being placed in the liquid ejection area, a discharge unit 50 for discharging the recording material 11 out of the liquid ejection, a step motor 60, and a control unit 80 for controlling the recording head 44.

The feed unit 20 includes a feed roller 22 and the retarder roller 24 which is rotated accompanying the feed roller 22. The feed roller 22 and the retarder roller 24 hold one of the recording materials 11 on top of the stack therebetween, which is being pushed out of the tray 12 by the hopper 124, and feed it towards the conveying unit 30 one by one.

The conveying unit 30 includes a feed roller 32 and driven feed rollers 34 which are rotated accompanying the feed roller 32. The feed roller 32 rotates holding the recording material 11 fed by the feed unit 20 between itself and the driven feed rollers 34, and conveys it to the liquid ejection area. Meanwhile, the driven feed rollers 34 are disposed above the feed roller 32. The rotation shaft of the driven feed rollers 34 is approximately parallel to the rotation shaft of the feed roller 32, and is disposed downstream of the feeding direction against the rotation shaft of the feed roller 32. Accordingly, the recording material 11 is conveyed obliquely downwards to the support member 100 by the feed roller 32 and the driven feed rollers 34. And the support member 100 supports the recording material 11 on the non-liquid ejection surface of it. Consequently, the recording material 11 is bent inwards on the surface where the liquid is ejected. Further, the feed roller 32 and the driven feed roller 34 are an example of a first transfer roller.

The recording unit 40 includes a carriage 42, a recording head 44 being mounted on the carriage 42, and a motor 48 for moving the carriage 42. The recording head 44 has a plurality of nozzles for ejecting liquid onto the recording material 11 being disposed in the liquid ejection area. Further, it includes a guide plate 46 for supporting the carriage 42 to be slidable in a main scanning direction which crosses the feeding direction of the recording material 11. The support member 100 is disposed below the recording head 44 with regard to the feeding direction.

The discharge unit 50 includes a discharge roller 52 and driven discharge rollers 54 which are rotated accompanying the discharge roller 52. The discharge roller 52 and the driven discharge rollers 54 rotate holding the recording material 11 therebetween, on which recording has been finished, and discharge it out of the liquid ejection area.

The driven discharge rollers 54 are disposed above the discharge roller 52. The rotation shaft of the driven discharge rollers 54 is approximately parallel to the rotation shaft of the discharge roller 52, and is disposed upstream of the feeding direction against the rotation shaft of the discharge roller 52. Accordingly, the recording material 11 is discharged obliquely upwards by the discharge roller 52 and the driven discharge rollers 54. Further, since the recording material 11 within the liquid ejection area exists upstream of the feeding direction to the discharge roller 52 and the driven discharge rollers 54, it is pushed towards the support member 100 by the discharge roller 52 and the driven discharge rollers 54. Consequently, the recording material 11 becomes bent inwards on the surface where the liquid is ejected. Further, the discharge roller 52 and the driven discharge roller 54 are an example of a first or second transfer roller.

Further, the conveying unit 30 and the discharge unit 50 transmit power from the step motor 60 via a belt 62. The belt 62 is applied with tension by a tensioner 64. The step motor 60, the tensioner 64, the conveying unit 30, and the discharge unit 50 are sequentially arranged in the flow direction of the belt 62.

The control unit 80 of the inkjet type recording apparatus 10 of the above configuration controls the recording head 44 to eject the liquid from its nozzles with the carriage 42 reciprocating along the guide plate 46. The control unit 80 controls the recording material 11 conveyed whenever the carriage 42 performs one scanning, so that the inkjet type recording apparatus 10 performs recording on the entire recording material 11 in the color or black and white mode. Further, the inkjet type recording apparatus 10 may perform recording in both the forward and backward paths of the recording head 44 or in only either of the paths. Further, the liquid ejection area of this embodiment is situated between the feed roller 32 and the driven feed rollers 34 and the discharge roller 52 and the driven discharge rollers 54 above the support member 100.

Here, the inkjet type recording apparatus 10 is an example of a liquid ejecting apparatus for performing recording by ejecting liquid onto recording materials. And the recording head 44 of the inkjet type recording apparatus 10 is an example of a liquid ejecting head of the liquid ejecting apparatus. The nozzles provided on the recording head 44 are an example of the ejection holes of the liquid ejecting head.

However, the present invention is not limited to this. As another example of the liquid ejecting apparatus, there is a color filter manufacturing apparatus for manufacturing a color filter of a liquid crystal display. In this case, a color material ejecting head of the color filter manufacturing apparatus is an example of the liquid ejecting head. Further another example of the liquid ejecting apparatus is an electrode forming apparatus for forming electrodes such as an organic EL display, a FED (Field Emission Display) or the like. In this case, an electrode material (conduction paste) ejecting head of the electrode forming apparatus is an example of the liquid ejecting head. Further another example is a biochip manufacturing apparatus for manufacturing biochips. In this case, a bio organism ejecting head of the biochip manufacturing apparatus and a sample ejecting head as a minute pipette are examples of the liquid ejecting head. The liquid ejecting apparatus of the present invention includes other liquid ejecting apparatuses used for industrial purposes. In addition, the recording material is a material on which recording is performed by ejection of liquid, which includes a recording paper, a circuit board on which circuit patterns such as display electrodes are formed, a CD-ROM for label recording, a preparation on which a DNA circuit is recorded.

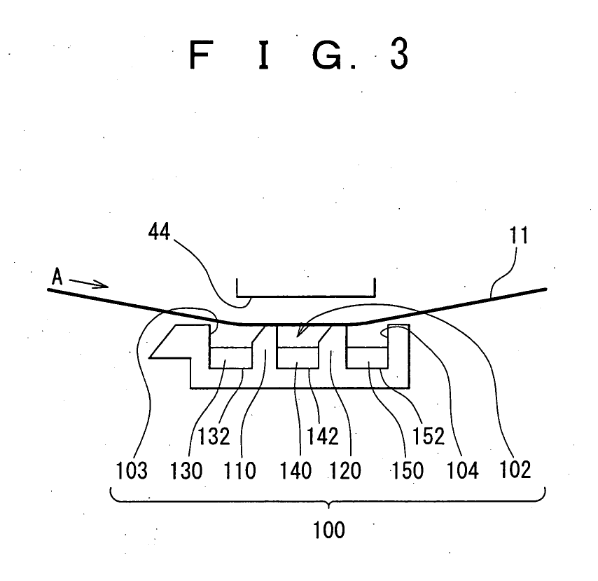

FIG. 3 shows a sectional view of the support member 100 together with the recording head 44. The support member 100 is disposed to face the recording head 44 with the recording material 11 interposed therebetween in the liquid ejection area. The support member 100 has recess sections 102 provided on its surface, upstream and downstream support ribs 110 and 120 disposed at the recess sections 102, first, third and second liquid absorption materials 130, 140 and 150, and upstream and downstream side surfaces 103 and 104.

The upstream and downstream support ribs 110 and 120 protrude from the bottoms of the recess sections 102, and are arranged along the feeding direction A of the recording material 11 in order to support the recording material 11 on its non-liquid ejection surface. The upstream and downstream support ribs 110 and 120 include inclined surfaces at the tops of their side surfaces upstream of the feeding direction A. Accordingly, the recording material 11 is smoothly conveyed over the upstream and downstream support ribs 110 and 120 in the feeding direction A.

The recess sections 102 have first, third and second groove sections 132, 142 and 152 between the upstream side surface 103, the upstream support ribs 110, the downstream support ribs 120 and the downstream side surface 104 respectively, where the groove sections are dented inwards to be lower than the ribs and extend in the main scanning direction.

The first liquid absorption material 130 is disposed between the upstream side surface 103 and the upstream support ribs 110, i.e. to fill the first groove section 132. The third liquid absorption material 140 is disposed between the upstream and downstream support ribs 110 and 120 in the feeding direction A of the recording material 11, i.e. to fill the third groove section 142. The second liquid absorption material 150 is disposed between the downstream side surface 104 and the downstream support ribs 120, i.e. to fill the second groove section 152. The support member 100 is designed in order that the liquid ejected from the recording head 44 does not stick to the upstream and downstream support ribs 110 and 120. Further, the upstream support rib 110 is an example of a first rib, and the downstream support rib 120 is an example of a second rib.

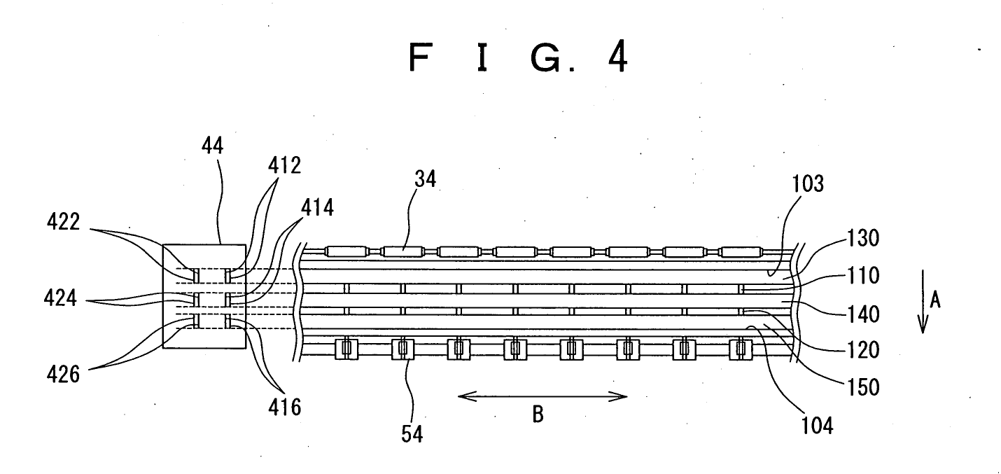

FIG. 4 shows the configuration of the nozzle arrays of the recording head 44 together with the plane configuration of the support member 100. The recording head 44 includes main nozzle arrays 412, 414 and 416. The main nozzle arrays 412 eject cyan liquid. The main nozzle arrays 414 eject magenta liquid. The main nozzle arrays 416 eject yellow liquid. The main nozzle arrays 412, 414 and 416 are separately arranged at different positions from each other in approximately the same line in the feeding direction A of the recording material 11. Therefore, when the recording head 44 ejects ink from the main nozzle arrays 412, 414 and 416 moving alternately backward and forward in the main scanning direction, recording is performed on the different positions of the recording material 11. The main nozzle arrays 412 is positioned most upstream of the feeding direction A among the three main nozzle arrays. The main nozzle arrays 416 is positioned most downstream of the feeding direction A among the three main nozzle arrays. Each of the main nozzle arrays is arranged in parallel with plurality.

The recording head 44 includes upstream sub-nozzle arrays 422, auxiliary sub-nozzle arrays 424, and downstream sub-nozzle arrays 426 to eject black liquid. The upstream, auxiliary and downstream sub-nozzle arrays 422, 424 and 426 are separately arranged from each other at different positions in approximately the same line in the feeding direction A of the recording material 11. Therefore, when the recording head 44 ejects ink from the upstream, auxiliary and downstream sub-nozzle arrays 422, 424 and 426 moving alternately backward and forward in the main scanning direction, recording is performed on the different positions of the recording material 11. The upstream sub-nozzle arrays 422 are arranged at approximately the same position in the feeding direction A as the main nozzle arrays 412. Accordingly, when the recording head 44 ejects ink from the upstream sub-nozzle arrays 422 and the main nozzle arrays 412 moving alternately backward and forward in the main scanning direction, recording is performed on approximately the same position of the recording material 11. The downstream sub-nozzle arrays 426 are arranged at approximately the same position in the feeding direction A as the main nozzle arrays 416. Accordingly, when the recording head 44 ejects ink from the downstream sub-nozzle arrays 426 and the main nozzle arrays 416 moving alternately backward and forward in the main scanning direction, recording is performed on approximately the same position of the recording material 11. The auxiliary sub-nozzle arrays 424 are arranged at approximately the same positions in the feeding direction A as the main nozzle arrays 414. Accordingly, when the recording head 44 ejects ink from the auxiliary sub-nozzle arrays 424 and the main nozzle arrays 414 moving alternately backward and forward in the main scanning direction, recording is performed on approximately the same position of the recording material 11. Further, each of the sub-nozzle arrays is arranged in parallel with plurality.

The upstream support ribs 110 of the support member 100 are disposed between the main nozzle arrays 412 and 414, e.g. downstream of the feeding direction A to the main nozzle arrays 412, and the first liquid absorption material 130 is disposed to include the arrangement position of the upstream sub-nozzle arrays 422 in the feeding direction A. The downstream support ribs 120 are disposed between the main nozzle arrays 414 and 416, e.g. upstream of the feeding direction A to the main nozzle arrays 416, and the second liquid absorption material 150 is disposed to include the arrangement position of the main nozzle arrays 416 in the feeding direction A. Accordingly, as described below, even though recording is performed on the upper and lower ends of the recording material 11 using cyan, yellow, and black liquid at the same time, the upstream and downstream support ribs 110 and 120 are not stuck with the liquid.

In addition, a plurality of the driven feed rollers 34 are provided at approximately the same position in the feeding direction A. In other words, the driven feed rollers 34 are arranged in a row along the main scanning direction B. And the driven feed rollers 34 are separated from each other.

A plurality of the upstream support ribs 110 are provided at approximately the same position in the feeding direction A. In other words, the upstream support ribs 110 are arranged in a row along the main scanning direction B. And the upstream support ribs 110 are separated from each other, and disposed at approximately same positions in the main scanning direction B as the driven feed rollers 34 respectively shown in FIG. 4. Accordingly, the distances between the driven feed rollers 34 and the upstream support ribs 110 corresponding to the driven feed rollers 34 in the main scanning direction B respectively are approximately the same in the feeding direction A.

In addition, a plurality of the downstream support ribs 120 are provided at approximately the same position in the feeding direction A. In other words, the downstream support ribs 120 are arranged in a row along the main scanning direction B. And the downstream support ribs 120 are separated from each other, and disposed at approximately same positions in the main scanning direction B as the driven feed rollers 34 respectively.

Further, a plurality of the driven discharge rollers 54 are provided at approximately the same position in the feeding direction A. In other words, the driven discharge rollers 54 are arranged in a row along the main scanning direction B. And the driven discharge rollers 54 are separated from each other, and disposed at approximately same positions in the main scanning direction B as the driven feed rollers 34 respectively.

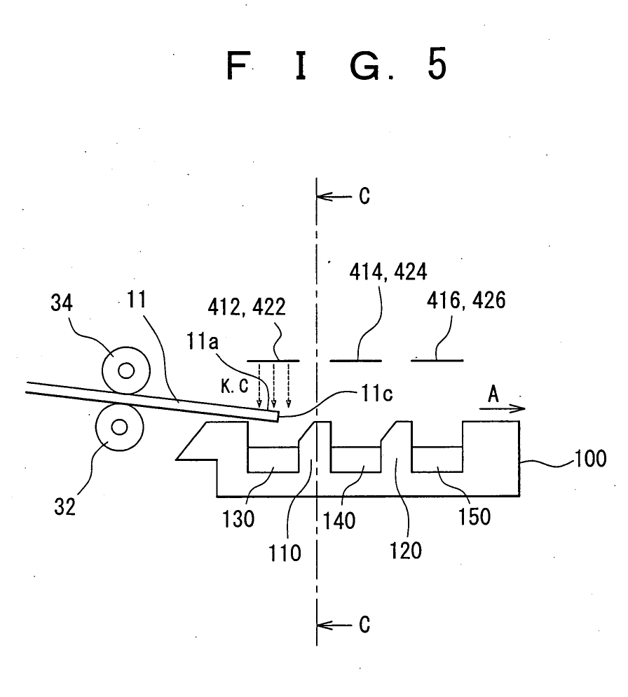

FIGS. 5 to 10 schematically show a recording sequence in which recording is performed onto the upper end 11a of the recording material 11. The control unit 80 controls the recording material 11 to be conveyed proceeding in the feeding direction A and thereby being distanced from the recording head 44 using the feed roller 32 and the driven feed rollers 34. And the control unit 80, as shown in FIG. 5, controls the upper end 11a of the recording material 11 conveyed to the position facing the upstream sub-nozzle arrays 422 and the main nozzle arrays 412. Then, when the upper end 11a of the recording material 11 is positioned below the upstream sub-nozzle arrays 422 and the main nozzle arrays 412, the control unit 80 moves the recording head 44 in the main scanning direction and controls the recording head 44 to eject cyan liquid (C) from the main nozzle arrays 412 onto the upper end 11a after or while ejecting black liquid (K) from the upstream sub-nozzle arrays 422. At this time, liquid is not ejected from other nozzle arrays.

Here, the black liquid (K) and cyan liquid (C) not sticking onto the upper end 11a is absorbed into the first liquid absorption material 130 without sticking onto the surface of the upstream support ribs 110. Therefore, the non-liquid ejection surface of the recording material 11 is hardly stained with the liquid when the recording material 11 is conveyed onto the upstream support ribs 110.

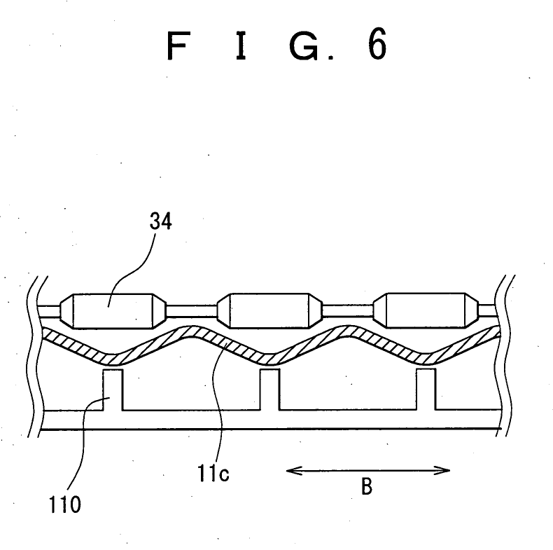

FIG. 6 shows a section C-C in FIG. 5. FIG. 6 shows a section 11c of the upper end of the recording material 11 together with the driven feed rollers 34 for the sake of description. The recording material 11 receives a force obliquely downwards by the feed roller 32 and the driven feed rollers 34. Since a plurality of the driven feed rollers 34 are provided being distanced from each other, the parts of the recording material 11 being positioned in the feeding direction approximately the same as the driven feed rollers 34 receive forces obliquely downwards, whereas parts of the recording material 11 not being positioned approximately the same as the driven feed rollers 34 do not receive forces obliquely downwards. Consequentially, as shown in FIG. 6, the section 11c of the upper end of the recording material 11 passing the driven feed rollers 34 is bent in the shape of a wave having its troughs at approximately the same positions in the main scanning direction B as the driven feed rollers 34 and the upstream support ribs 110.

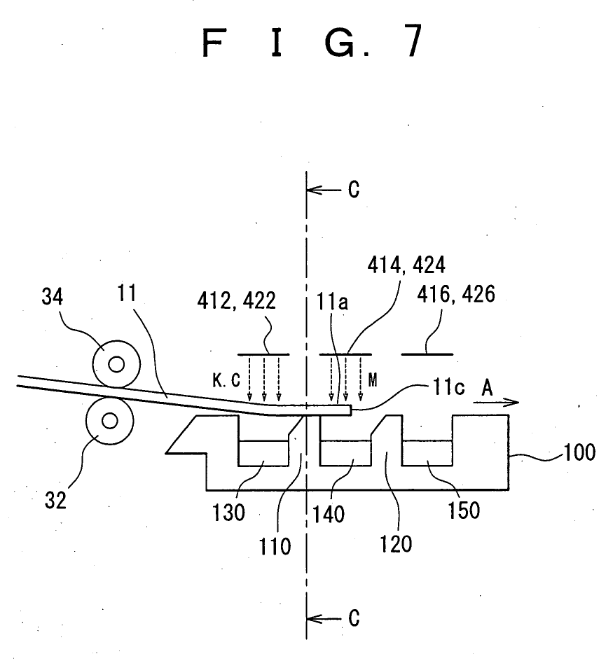

Then, as shown in FIG. 7, the control unit 80 controls the upper end 11a of the recording material 11 to be conveyed to the position facing the auxiliary sub-nozzle arrays 424 and the main nozzle arrays 414. And the control unit 80 moves the recording head 44 in the main scanning direction and controls the recording head 44 to eject magenta liquid (M) from the main nozzle arrays 414 onto the upper end 11a. At this time, the control unit 80 controls the recording head 44 to eject black liquid (K) from the upstream sub-nozzle arrays 422 and cyan liquid (C) from the main nozzle arrays 412 respectively onto areas except the upper end 11a of the recording material 11, but not from the auxiliary sub-nozzle arrays 424, the downstream sub-nozzle arrays 426, and the main nozzle arrays 416.

Here, the magenta liquid (M) not sticking onto the upper end 11a is absorbed in to the third liquid absorption material 140 without sticking onto the surface of the downstream support ribs 120. Therefore, the non-liquid ejection surface of the recording material 11 is hardly stained with the liquid when the recording material 11 is conveyed onto the upstream and downstream support ribs 110 and 120.

In addition, since the upper end 11a receives a force which causes it distanced from the recording head 44 by the feed roller 32 and the driven feed rollers 34, the recording material 11 between the feed roller 32 and the driven feed rollers 34 and the upstream support ribs 110 is bent inwards on the liquid ejection surface of the recording material 11 in the feeding direction A. Further, the upper end 11a is supported from the non-liquid ejection surface towards the recording head 44 by the upstream support ribs 110.

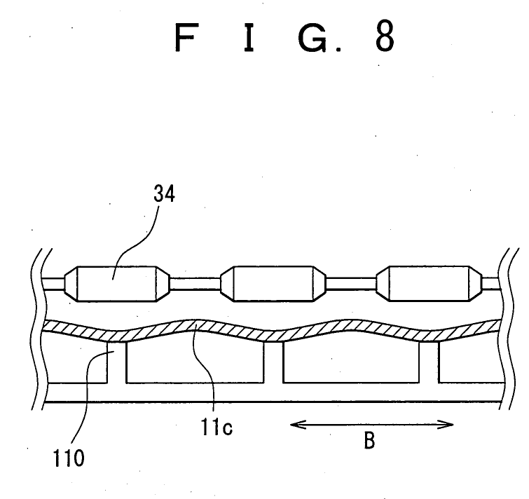

FIG. 8 shows a section C-C in FIG. 7. FIG. 8 shows a section 11c of the upper end of the recording material 11 together with the driven feed rollers 34 for the sake of description. The section 11c of the upper end of the recording material 11 is bent in the shape of a wave in the main scanning direction B by the feed roller 32 and the driven feed rollers 34. Since the upstream support ribs 110 are positioned in the feeding direction B approximately the same as the driven feed rollers 34, they are supporting the trough parts of the wave-shaped bent recording material 11. Further, since the recording material 11 receives a force which causes it distanced from the recording head 44 by the feed roller 32 and the driven feed rollers 34, the trough parts of the wave-shaped bent recording material 11 are pressed onto the upstream support ribs 110. Accordingly, the wave-shaped bends of the recording material 11 caused by the feed roller 32 and the driven feed rollers 34 are reduced by the upstream support ribs 110.

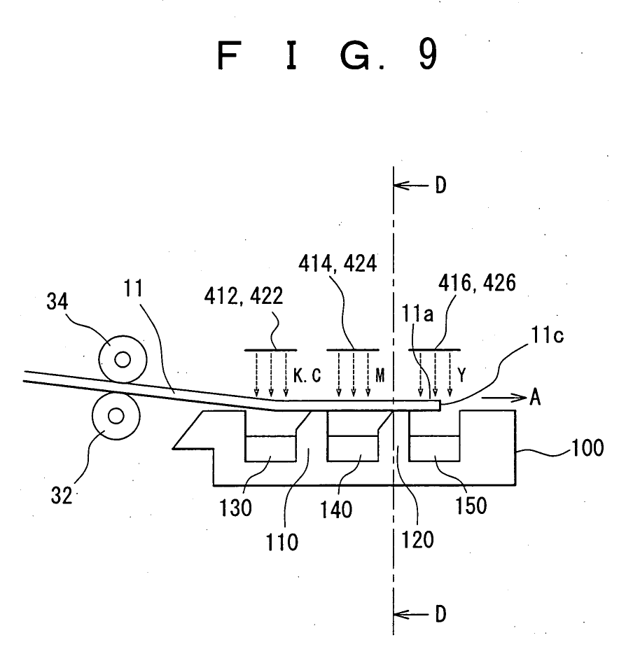

Then, as shown in FIG. 9, the control unit 80 controls the upper end 11a of the recording material 11 conveyed to the position facing the downstream sub-nozzle arrays 426 and the main nozzle arrays 416. And the control unit 80 moves the recording head 44 in the main scanning direction and controls the recording head 44 to eject yellow liquid (Y) from the main nozzle arrays 416 onto the upper end 11a. At this time, it controls the recording head 44 to eject yellow liquid (K) from the upstream sub-nozzle arrays 422, cyan liquid (C) from the main nozzle arrays 412, and magenta liquid (M) from the main nozzle arrays 414 respectively onto the area except the upper end 11a of the recording material 11, but not from the auxiliary sub-nozzle arrays 424 and the downstream sub-nozzle arrays 426.

Here, the yellow liquid (Y) not sticking onto the upper end 11a is absorbed into the second liquid absorption material 150 without sticking onto the surface of the downstream support ribs 120. Therefore, the non-liquid ejection surface of the recording material 11 is hardly stained with the liquid when the recording material 11 is conveyed onto the downstream support ribs 120.

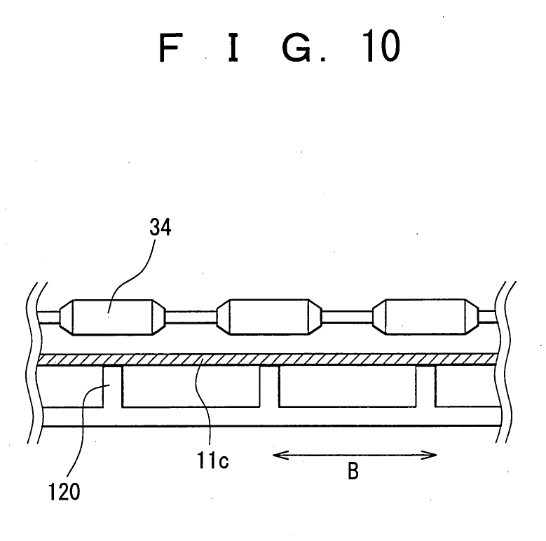

FIG. 10 shows a section D-D in FIG. 9. FIG. 10 shows a section 11c of the upper end of the recording material 11 together with the driven feed rollers 34 for the sake of description. When the upper end 11a is placed at the position facing the downstream sub-nozzle arrays 426 and the main nozzle arrays 416, it is supported from the non-liquid ejection surface towards the recording head 44 by the downstream support ribs 120.

Since the downstream support ribs 120 are positioned in the feeding direction B approximately the same as the driven feed rollers 34 and the upstream support ribs 110, they support the trough parts of the wave-shaped bends of the recording material 11 caused by the feed roller 32 and the driven feed rollers 34. Further, the recording material 11 receives a force which causes it distanced from the recording head 44 by the feed roller 32 and the driven feed rollers 34, the trough parts of the wave-shaped bends of the recording material 11 are pressed onto the downstream support ribs 120. Accordingly, the wave-shaped bends of the recording material 11 caused by the feed roller 32 and the driven feed rollers 34 are further suppressed by the downstream support ribs 120. In this way, since the wave-shaped bends of the recording material 11 within the liquid ejection area are suppressed, the inkjet type recording apparatus 10 can record an image onto the recording material 11 accurately.

As above, black, cyan, magenta and yellow liquid is ejected onto the upper end 11a of the recording material 11. Accordingly, recording is performed on the upper end 11a in various colors. Therefore, the inkjet type recording apparatus 10 can perform recording with no margin on the recording material 11 with no parts of the liquid ejection surface of the upper end 11a, which are not stuck with liquid. In addition, since black ink is ejected from the upstream sub-nozzle arrays 422 which are the most upstream sub-nozzle arrays, it firstly sticks to the upper end 11a of the recording material 11. Accordingly, black is hardly spread. Therefore, recording quality is improved.

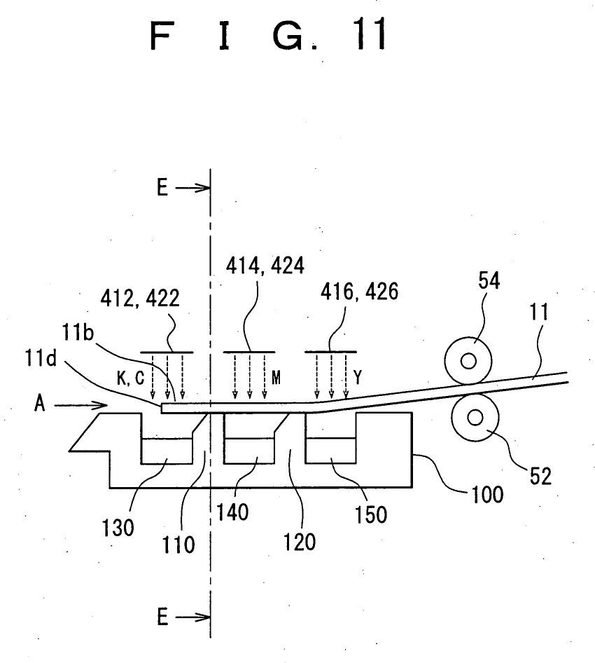

FIGS. 11 to 16 schematically show a recording sequence in which recording is performed onto the lower end 11b of the recording material 11. The control unit 80, as shown in FIG. 11, controls the lower end 11b of the recording material 11 to be conveyed to the position facing the upstream sub-nozzle arrays 422 and the main nozzle arrays 412. And when the lower end 11b of the recording material 11 is positioned below the upstream sub-nozzle arrays 422 and the main nozzle arrays 412, the control unit 80 moves the recording head 44 in the main scanning direction and controls the recording head 44 to eject cyan liquid (C) from the main nozzle arrays 412 onto the lower end 11b after or while ejecting black liquid (K) from the upstream sub-nozzle arrays 422. At this time, the control unit 80 controls the liquid ejected from the main nozzle arrays 414 and 416 onto the recording material 11, but not from the auxiliary sub-nozzle arrays 424 and the downstream sub-nozzle arrays 426.

Here, black liquid (K) and cyan liquid (C) not sticking to the recording material 11 is absorbed into the first liquid absorption material 130 without sticking onto the surface of the upstream support ribs 110. Therefore, the following non-liquid ejection surface of the recording material 11 is hardly stained with the liquid when conveyed onto the upstream support ribs 110.

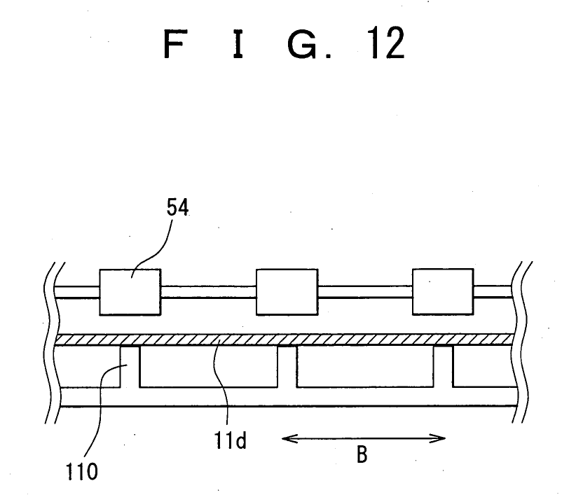

FIG. 12 shows a section E-E in FIG. 11. FIG. 12 shows the section 11d of the lower end of the recording material 11 together with the driven discharge rollers 54 for the sake of description. When the lower end 11b is placed at the position facing the main nozzle arrays 412 and the upstream sub-nozzle arrays 422, the lower end 11b is supported from the non-liquid ejection surface towards the recording head 44 by the upstream support ribs 110.

And since the rotation shaft of the driven discharge rollers 54 are disposed closer to the liquid ejection area than the rotation shaft of the discharge roller 52, the parts of the recording material 11 which are interposed between the discharge roller 52 and the driven discharge rollers 54 receive forces downwards. Since a plurality of the driven discharge rollers 54 are separately provided from each other, the parts of the recording material 11 which are not positioned in the main scanning direction approximately the same as the driven discharge rollers 54 do not receive forces downwards. Consequently, the section 11d of the lower end of the recording material 11 is bent in the shape of a wave having its troughs at approximately the same positions in the main scanning direction B as the driven discharge rollers 54.

Since the rotation shift of the driven discharge rollers 54 exist closer to the liquid ejection area than the rotation shift of the discharge roller 52, the recording material 11 within the liquid ejection area is pressed onto the upstream and downstream support ribs 110 and 120. And since the upstream and downstream support ribs 110 and 120 are positioned in the main scanning direction B approximately the same as the driven discharge rollers 54, the trough parts of the wave-shaped bent the recording material 11 are supported upwards by the upstream and downstream support ribs 110 and 120. Accordingly, the wave-shaped bends of the recording material 11 are reduced on the upstream support ribs 120. And since the upstream and downstream support ribs 110 and 120 are positioned in the feeding direction B approximately the same, the wave-shaped bends of the recording material 11 which have become small by the upstream support ribs 120 become further small on the upstream support ribs 110.

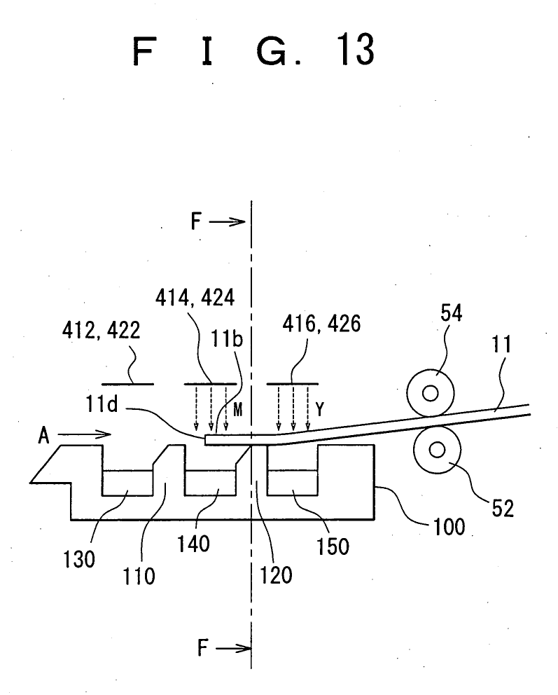

Then, as shown in FIG. 13, the control unit 80 controls the lower end 11b of the recording material 11 conveyed to the position facing the auxiliary sub-nozzle arrays 424 and the main nozzle arrays 414. And the control unit 80 moves the recording head 44 in the main scanning direction and controls it to eject magenta liquid (M) from the main nozzle arrays 414. At this time, the inkjet type recording apparatus 10 continues ejecting yellow liquid (Y) from the main nozzle arrays 416 onto the recording material 11, but not from the main nozzle arrays 412, the upstream sub-nozzle arrays 422, the auxiliary sub-nozzle arrays 424, and the downstream sub-nozzle arrays 426.

Here, magenta liquid (M) not sticking to the recording material 11 is absorbed into the third liquid absorption material 140 without sticking onto the surface of the upstream support ribs 110. Accordingly, the following non-liquid ejection surface of the recording material 11 is hardly stained with the liquid when conveyed onto the upstream support ribs 110.

And when the lower end 11b exist at the position facing the auxiliary sub-nozzle arrays 424 and the main nozzle arrays 414, the lower end 11b is supported from the non-liquid ejection surface towards the recording head 44 by the downstream support ribs 120. Since the lower end 11b receives a force which causes it distanced from the recording head 44 by the discharge roller 52 and the driven discharge rollers 54, the recording material 11 between the discharge roller 52 and the driven discharge rollers 54 and the downstream support ribs 120 is bent inwards on the liquid ejection surface of the recording material 11 in the feeding direction A.

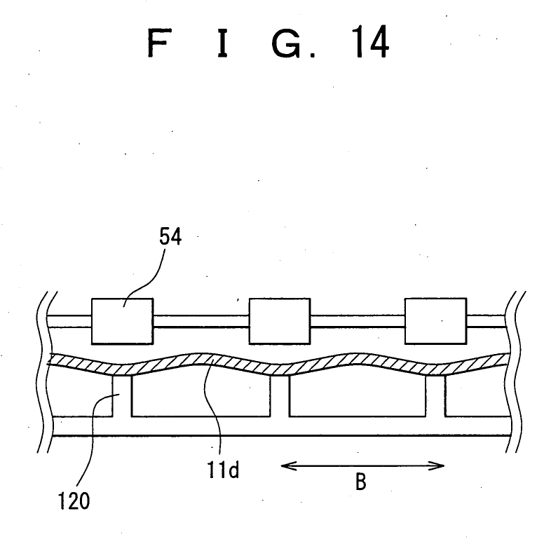

FIG. 14 shows a section F-F in FIG. 13. FIG. 14 shows the section 11d of the lower end of the recording material 11 together with the driven discharge rollers 54 for the sake of description. The recording material 11 is pressed onto the downstream support ribs 120 by the driven discharge rollers 54 and the discharge roller 52. Further, when the lower end 11b exists at the position facing the main nozzle arrays 414 and the auxiliary sub-nozzle arrays 424, the lower end 11b is supported from the non-liquid ejection surface towards the recording head 44 by the downstream support ribs 120. Particularly, the trough parts of the wave-shaped bends caused by the discharge roller 52 and the driven discharge rollers 54 are supported upwards by the downstream support ribs 120. Accordingly, the wave-shaped bends caused by the discharge roller 52 and the driven discharge rollers 54 become small on the downstream support ribs 120.

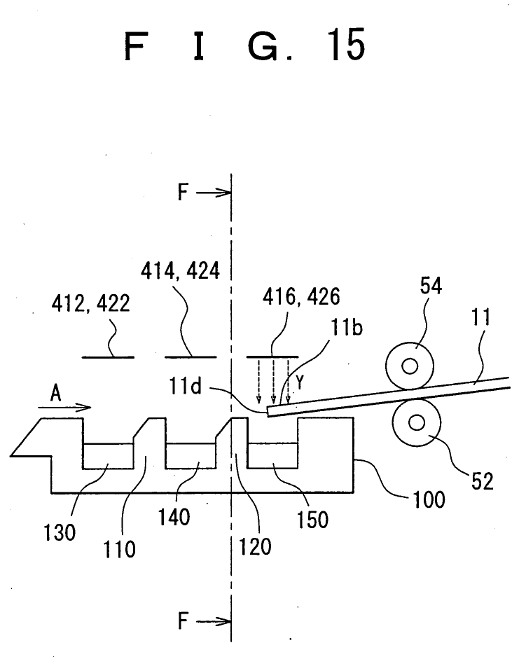

Then, as shown in FIG. 15, the control unit 80 controls the lower end 11b of the recording material 11 conveyed to the position facing the main nozzle arrays 416 and the downstream sub-nozzle arrays 426. And the control unit 80 moves the recording head 44 in the main scanning direction and controls the recording head 44 to eject yellow liquid (Y) from the main nozzle arrays 416 onto the lower end 11b. At this time, liquid is not ejected from other nozzle arrays.

Here, yellow liquid (Y) not sticking onto the recording material 11 is absorbed into the second liquid absorption material 150 without sticking onto the surface of the downstream support ribs 120. Accordingly, the following non-liquid ejection surface of the recording material 11 is hardly stained with the liquid when conveyed onto the downstream support ribs 120.

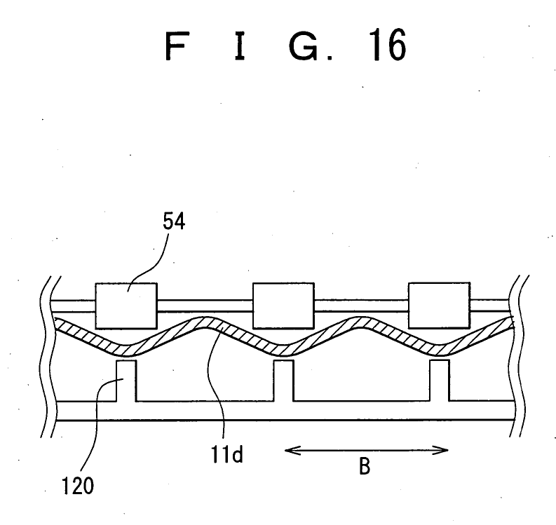

FIG. 16 shows a section F-F in FIG. 5. FIG. 16 shows a section 11d of the lower end of the recording material 11 together with the driven discharge rollers 54 for the sake of description. When the lower end 11b is placed at the position facing the main nozzle arrays 416 and the downstream sub-nozzle arrays 426, the lower end 11b passing over the downstream support ribs 120 receives a force obliquely downwards by the discharge roller 52 and the driven discharge rollers 54. Accordingly, the section 11d of the lower end, as shown in FIG. 16, is bent in the shape of a wave having its troughs at approximately the same positions in the main scanning direction B as the driven discharge rollers 54.

As above, black, cyan, magenta and yellow liquid is ejected onto the lower end 11b of the recording material 11. Accordingly, recording is performed onto the lower end 11b in various colors. Therefore, the inkjet type recording apparatus 10 can perform recording with no margin on the recording material 11 with no parts of the liquid ejection surface of the lower end 11b, which are not stuck with liquid. In addition, since black ink is ejected from the upstream sub-nozzle arrays 422 which are the most upstream sub-nozzle arrays, it firstly sticks to the lower end 11b of the recording material 11. Accordingly, black is hardly spread. Therefore, recording quality is improved.

Further, even when ink is ejected onto areas except the upper and lower ends of the recording material 11, recording is performed in the same sequence as that in case of the upper and lower ends of the recording material 11. Since black ink (K) is ejected from the upstream sub-nozzle arrays 422, it firstly sticks to the recording material 11. Accordingly, black is hardly spread. Therefore, recording quality is improved.

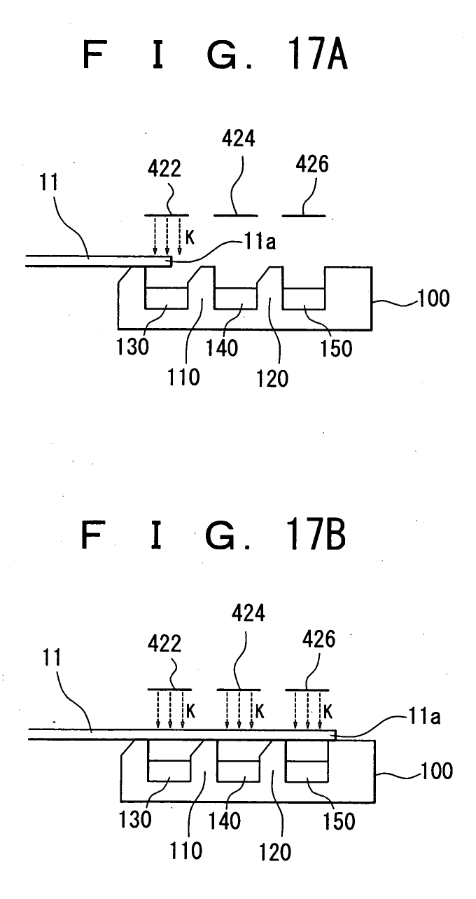

FIGS. 17A and 17B show recording sequences in which the inkjet type recording apparatus 10 performs recording on the upper end 11a of the recording material 11 in the black and white mode. In FIGS. 17A and 17B, the main nozzle arrays 412, 414 and 416 are not shown because they are not used.

When the upper end 11a of the recording material 11 is positioned below the upstream sub-nozzle arrays 422, as shown in FIG. 17A, the control unit 80 controls black ink (K) ejected from the upstream sub-nozzle arrays 422. Here, ink not sticking onto the recording material 11 is absorbed into the first liquid absorption material 130 without sticking onto the surface of the upstream support ribs 110. Accordingly, the non-recording surface of the recording material 11 is hardly stained with the ink when conveyed on the upstream support ribs 110.

And as shown in FIG. 17B the control unit 80 performs recording using all of the upstream sub-nozzle arrays 422, the auxiliary sub-nozzle arrays 424, and the downstream sub-nozzle arrays 426 after conveying the recording material 11 up to the position where the upper end 11a goes beyond the downstream sub-nozzle arrays 426. Accordingly, the recording throughput to the recording material 11 is improved.

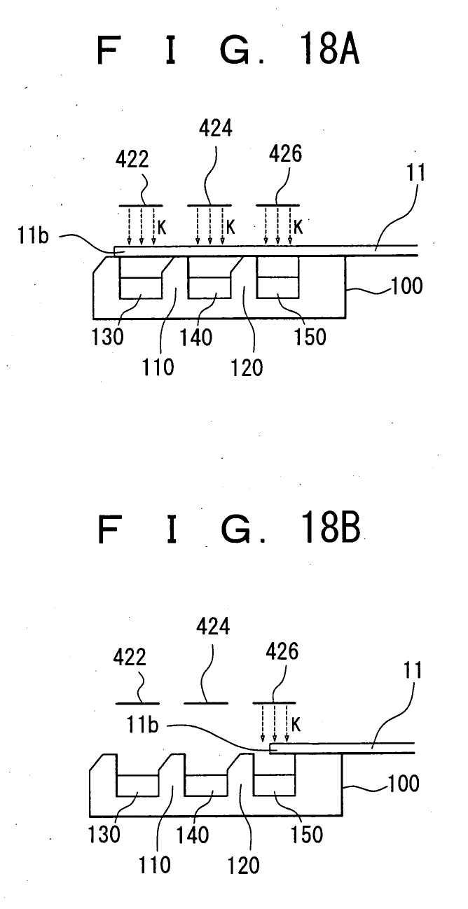

FIGS. 18A and 18B show recording sequences in which the inkjet type recording apparatus 10 performs recording on the lower end 11b of the recording material 11 in the black and white mode. 18A and 18B, the main nozzle arrays 412, 414 and 416 are not shown because they are not used.

As shown in FIG. 18A the control unit 80 uses all of the upstream sub-nozzle arrays 422, the auxiliary sub-nozzle arrays 424, and the downstream sub-nozzle arrays 426 until the lower end 11b of the recording material 11 comes in below the upstream sub-nozzle arrays 422 so as to improve the recording throughput to the recording material 11.

And when the control unit 80 performs recording onto the lower end 11b as shown in FIG. 18B, it controls the lower end 11b of the recording material 11 conveyed below the downstream sub-nozzle arrays 426. And black ink (K) is ejected from the downstream sub-nozzle arrays 426 onto the lower end 11b. Accordingly, recording is performed onto the lower end 11b.

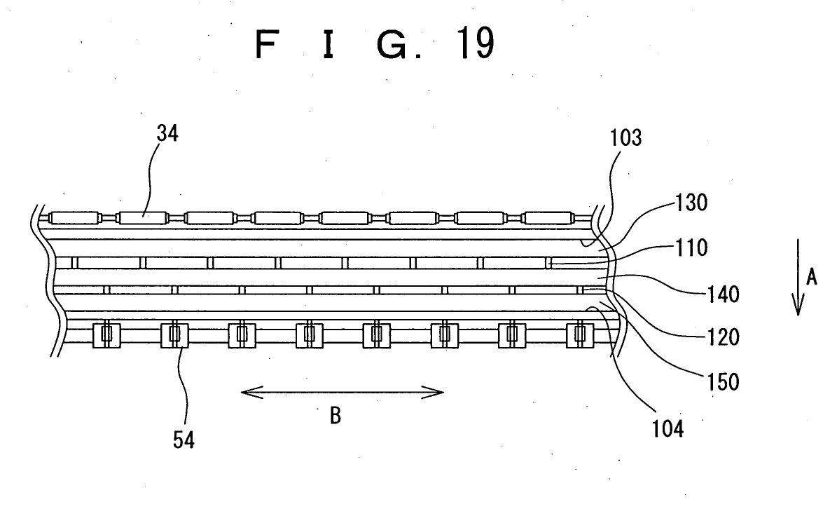

FIG. 19 shows a modified embodiment of the plane configuration of the support member 100. In the support member 100 shown in FIG. 19, the same configuration as that of the support member 100 in FIG. 4 is given the same symbols as those in FIG. 4, and it will not be described.

The upstream support ribs 110 of the support member 100 shown in FIG. 19 are positioned in the main scanning direction B approximately the same as the driven feed rollers 34 respectively. The downstream support ribs 120 are positioned in the main scanning direction B approximately the same as the driven discharge rollers 54 respectively. In this modified embodiment, however, the upstream support ribs 110 and the downstream support ribs 120 are not arranged in approximately the same line in the main scanning direction B.

Even in this configuration, the bends of the recording material 11 caused by the feed roller 32 and the driven feed rollers 34 are suppressed by the upstream support ribs 110, whereas the bends of the recording material 11 caused by the discharge roller 52 and the driven discharge rollers 54 are suppressed by the downstream support ribs 120. Therefore, the inkjet type recording apparatus 10 can prevent the recording material 11 from bending in the shape of a wave within the liquid ejection area, and perform recording onto the recording material 11 accurately.

As obvious from the above description, since the inkjet type recording apparatus 10 of this embodiment has the recess sections 102 at the position facing the nozzle arrays, it can perform recording accurately up to the upper end 11a and the lower end 11b of the recording material 11 in the feeding direction without staining the non-liquid ejection surface of the recording material 11. In addition, since the inkjet type recording apparatus 10 supports the recording material 11 upwards by the upstream and downstream support ribs 110 and 120, it suppresses the wave-shaped bends of the recording material 11 causes by the feed roller 32 and the driven feed rollers 34 and the discharge roller 52 and the driven discharge rollers 54, so that it can perform recording onto the recording material 11 accurately.

Further, the recording head 44 of the inkjet type recording apparatus 10 in this embodiment has a plurality main nozzle arrays for ejection of liquid in a plurality of colors being arranged in a row in the feeding direction of the recording material 11, and a plurality of sub-nozzle arrays for ejection of black liquid being arranged in parallel to the main nozzle arrays in the feeding direction of recording material 11. Accordingly, when it performs recording onto the upper end, it ejects black liquid from the most upstream sub-nozzle arrays. Therefore, black is hardly spread. In addition, the recording throughput in the black and white mode is improved.

Although the present invention has been described by way of exemplary embodiments, it should be understood that those skilled in the art might make many changes and substitutions without departing from the spirit and the scope of the present invention which is defined only by the appended claims.

What is claimed is:

1. A liquid ejecting apparatus for performing recording on a recording material conveyed to a liquid ejection area by ejecting liquid onto said recording material, comprising:
a plurality of first transfer rollers separately provided from each other in a substantially same line along a main scanning direction crossing a feeding direction of said recording material, for transferring said recording material in said feeding direction while bending said recording material inwards on a liquid ejection surface of said recording material in said liquid ejection area;
a plurality of first ribs disposed in said liquid ejection area for supporting said recording material on a surface of said recording material opposite said liquid ejection surface, said first ribs being placed at substantially same positions in said main scanning direction as said first transfer rollers respectively, directions and distances of said first ribs from said first transfer rollers in said feeding direction being substantially equal to each other; and
a first liquid absorption material disposed between said first transfer rollers and said first ribs for absorbing said liquid.

2. A liquid ejecting apparatus as claimed in claim 1, wherein said first transfer rollers convey said recording material to said liquid ejection area, and
said first ribs are disposed downstream of said feeding direction of said recording material against said first transfer rollers.

3. A liquid ejecting apparatus as claimed in claim 2 further comprising:
a plurality of second transfer rollers disposed downstream of said feeding direction of said recording material against said first liquid absorption material, for conveying said recording material out of said liquid ejection area while bending said recording material inwards on a liquid ejection surface of said recording material in said liquid ejection area;
a plurality of second ribs disposed in said liquid ejection area for supporting said recording material on said surface of said recording material opposite said liquid ejection surface, said second ribs being placed at substantially same positions in said main scanning direction as said second transfer rollers respectively, and being placed at a substantially same position between said second transfer rollers and said first ribs in said feeding direction; and
a second liquid absorption material disposed between said second transfer rollers and said second ribs for absorbing said liquid.

4. A liquid ejecting apparatus as claimed in claim 3, wherein said second transfer rollers and second ribs are arranged at substantially same positions in main scanning direction as said first transfer rollers and first ribs respectively.

5. A liquid ejecting apparatus as claimed in claim 1, wherein said first transfer rollers convey said recording material out of said liquid ejection area, and
said first ribs are disposed upstream of said feeding direction of said recording material against said first transfer rollers.

6. A liquid ejecting apparatus for performing recording on a recording material by ejecting liquid onto said recording material, comprising:
a liquid ejecting head reciprocating in a main scanning direction substantially crossing a feeding direction of said recording material;
a plurality of main nozzle arrays separately provided from each other in said feeding direction on a surface of said liquid ejecting head facing said recording material for ejecting different main liquid respectively;
an upstream sub-nozzle array provided on said surface of said liquid ejecting head facing said recording material for ejecting sub-liquid onto an area different from that of said main liquid, said upstream sub-nozzle array being disposed at a substantially same position in said feeding direction as one of said main nozzle arrays positioned most upstream of said feeding direction;
at least one support rib disposed to face areas between said main nozzle arrays via said recording material for supporting said recording material; and
a control unit for controlling said sub-liquid to be ejected from said upstream sub-nozzle array, when said main and sub-liquid is ejected onto an upper end of said recording material.

7. A liquid ejecting apparatus as claimed in claim 6, wherein said liquid ejecting head further comprises a downstream sub-nozzle array provided at a substantially same position in said feeding direction as one of said main nozzle arrays positioned most downstream of said feeding direction for ejecting said sub-liquid onto an area different from that of said main liquid, and
said control unit uses said upstream sub-nozzle array when said sub-liquid is ejected onto said upper end of said recording material, whereas using said downstream sub-nozzle array when said sub-liquid is ejected onto a lower end of said recording material, in case only said sub-liquid is ejected onto said recording material without ejection of said main liquid.

8. A liquid ejecting apparatus as claimed in claim 7 further comprising: an auxiliary sub-nozzle array disposed between said upstream and downstream sub-nozzle arrays in said feeding direction,
wherein said control unit uses said upstream, downstream, and auxiliary sub-nozzle arrays when said sub-liquid is ejected onto an area except said upper and lower ends of said recording material.

9. A liquid ejecting apparatus as claimed in claim 6, wherein said liquid ejecting apparatus is an inkjet type recording apparatus, and
said liquid ejecting head ejects ink of a plurality of colors except black for color recording from said plurality of main nozzle arrays, where as ejecting black ink from said sub-nozzle arrays.

10. A liquid ejecting apparatus for performing recording on a recording material by ejecting liquid onto said recording material, comprising:
a liquid ejecting head reciprocating in a main scanning direction substantially crossing a feeding direction of said recording material;
a plurality of nozzle arrays separately provided from each other in said feeding direction on a surface of said liquid ejecting head facing said recording material for ejecting liquid respectively; and
at least one support rib disposed to face areas between said main nozzle arrays via said recording material for supporting said recording material;
wherein a plurality of recess sections are formed extending in said main scanning direction at positions facing said nozzle arrays via said recording material respectively and dented to be lower than said support rib around said support rib.

11. A liquid ejecting apparatus as claimed in claim 10 further comprising: at least one liquid absorption material disposed in said recess sections for absorbing liquid ejected from said nozzle arrays.

12. A liquid ejecting apparatus as claimed in claim 10 further comprising:
a plurality of first transfer rollers separately provided from each other in an approximately same line along said main scanning direction, for transferring said recording material in said feeding direction while bending said recording material inwards on a liquid ejection surface of said recording material at a position facing said liquid ejecting head; and
a plurality of second transfer rollers disposed downstream of said feeding direction against said support rib, for conveying said recording material out of said position facing said liquid ejecting head while bending said recording material inwards on said liquid ejection surface at said position facing said liquid ejecting head,
wherein said support rib comprises:
a plurality of first ribs placed at substantially same positions in said main scanning direction as said first transfer rollers respectively, directions and distances of said first ribs from said first transfer rollers in said feeding direction being substantially equal to each other; and
a plurality of second ribs placed at substantially same positions in said main scanning direction as said second transfer rollers respectively, and being placed at a substantially same position between said second transfer rollers and said first ribs in said feeding direction.

13. A liquid ejecting apparatus as claimed in claim 10 further comprising: a control unit for controlling said nozzle arrays, wherein said plurality of nozzle arrays comprises:
an upstream nozzle array; and
a downstream nozzle array disposed downstream of said feeding direction against said upstream nozzle array, and
said control unit uses said upstream nozzle array when said liquid is ejected onto an upper end of said recording material, whereas using said downstream nozzle array when said liquid is ejected onto a lower end of said recording material.
